(19) United States
(12) Patent Application Publication
(10) Pub. No.: US 2014/0166767 A1
(43) Pub. Date: Jun. 19, 2014

(54) PORTABLE MOTORIZED FLUID DELIVERY DEVICE APPARATUS AND METHODS

(71) Applicant: BLUE VIPER, LLC, Nashville, TN (US)

(72) Inventors: Williams L. Michael, Old Hickory, TN (US); Martin J. Strobel, JR., Nashville, TN (US)

(73) Assignee: BLUE VIPER, LLC, Nashville, TN (US)

(21) Appl. No.: 13/715,567

(22) Filed: Dec. 14, 2012

(51) Int. Cl. A01M 7/00

(52) U.S. Cl. CPC A01M 7/0046
USPC 239/1; 239/375; 29/592.1

(57) ABSTRACT

Devices and methods are provided relating generally to the delivery of fluids in the context of the lawn and garden industry. The devices and methods provide for the delivery of fluids at specified droplet size, pressure, spray pattern, and dispersal location relative to the target. The devices and methods deliver various fluids to a targeted location in a manner that limits the physical exertion typically required of users for such applications and is highly precise and accurate, thus reducing the likelihood and extent of missing the target and wasting expensive resources.

### FIELD

The present inventive concept relates generally to the delivery of fluids in the context of the lawn and garden industry. In particular, the general inventive concept relates to the delivery of fluids at specified droplet size, pressure, spray pattern, and dispersal location relative to the target. Specifically, the invention relates to an apparatus and related methods for efficiently and economically delivering various agricultural, horticultural, and gardening fluids, including but not limited to herbicides and fertilizers, to a targeted location in a manner that limits the physical exertion typically required of users for such applications and is highly precise and accurate, thus reducing the likelihood and extent of missing the target.

### BACKGROUND

Agricultural, horticultural, and gardening endeavors often use fluids such as herbicides, pesticides, fertilizers and related products for a number of reasons, such as to maximize yield or to promote intended aesthetic design. The manner of delivery of these fluids often presents a quandary to users, whether the user is an individual or a larger scale commercial operation in the field at large. For example, the application of herbicides and other fluids often involves repetitive actions that can be physically taxing and labor intensive to the user, which can lead to fatigue, which in turn can lead to accidents, mistakes, injury or even death. Additionally, the matter of proper application of an herbicide or other fluid presents problems of efficient product use and effective product application.

Many devices and methods are available to assist in the application of agricultural fluids. Some examples include: U.S. Published Patent Application No. 2010/0288853; U.S. Published Patent Application No. 2011/0253803; U.S. Pat. No. 3,692,512; U.S. Pat. No. 6,190,077; U.S. Published Patent Application No. 2006/0049214; U.S. Published Patent Application No. 2005/0029310; U.S. Published Patent Application No. 2010/0044456; U.S. Pat. No. 5,419,078; and U.S. Published Patent Application No. 2005/0082389. Some additional examples include: U.S. Pat. No. 5,108,036; European Patent Publication No. 0 487 800; European Patent Publication No. 0 300 762; U.S. Pat. No. 6,443,368; U.S. Pat. No. 6,029,589; U.S. Pat. No. 7,036,751; U.S. Pat. No. 6,595,437; U.S. Pat. No. 6,047,900; U.S. Published Patent Application No. 2007/0119972; U.S. Published Patent Application No. 2010/0163646; U.S. Published Patent Application No. 2012/0223160; U.S. Pat. No. 5,395,052; U.S. Pat. No. 5,822,968; U.S. Pat. No. 6,367,714; U.S. Pat. No. 6,663,307; U.S. Pat. No. 7,588,198; and U.S. Pat. No. 8,083,155.

All of the above referenced examples have shortcomings. Some examples of the shortcomings of the prior art include requiring too much fluid. Often, the fluids to be dispersed require such high volumes that the fluid is sold in a concentrated state. These fluids must be diluted to reach optimal volume and concentration levels. Problems are encountered when fluid levels are too concentrated or too diluted, compromising effectiveness and potentially damaging plants and animals in the vicinity. A greater volume of fluid is heavier and bulkier than a lesser volume, increasing the physical exertion required for proper transport and use. The fluids being dispersed are expensive and environmental conditions such as wind can make it difficult to disperse the fluids in the intended quantities and limited to a specific target area. In other words, spraying too much results in waste and harm to nearby plants while spraying too little compromises effectiveness.

The inventors have developed new devices and related methods to overcome these and other shortcomings of the prior art. The inventors have discovered that by dispersing fluids at relatively high pressure and using a mist of preferred droplet size, a much lesser volume of concentrated fluids can be used to achieve the same or greater effectiveness at the same or lower costs than the prior art.

### SUMMARY

One object of the present inventive concept is to provide a portable motorized fluid delivery device apparatus. The device includes a handle that is ergonomically designed to be comfortably held by the user with one hand. The handle is sized and shaped such that it can contain fluid. The handle also includes an electrical switch that, when activated, controls the dispersal of fluid. The switch is connected to an electrical power source.

The device includes an elongated shaft that extends away from the handle. At the end of the shaft are a base and a nozzle. The device includes an electrical motor and fluid pump. The electrical motor and fluid pump are connected to the switch and power source such that the fluid is pumped from the container in the handle, down the shaft and out through the nozzle in the base. The fluid is dispersed in a special spray pattern such that it exits the nozzle at approximately 10 to 45 psi and the fluid droplets are medium to coarse (100 to 450 microns) in size.

In some exemplary embodiments discussed in further detail below, the fluid is an herbicide and/or indicator (e.g., colored dye), the handle includes a removable container to hold and transfer the fluid, and the base includes a hood that surrounds the nozzle and extends beyond the point where fluid is ejected from the nozzle to aid the user in maintaining a consistent distance between the nozzle and the target and also to reduce the influence of wind and other environmental factors on fluid dispersal pattern after the fluid leaves the nozzle.

A device of the present inventive concept alleviates much of the fatigue and physical exertion typically associated with agricultural endeavors. For example, the application of herbicides and related liquids often involves bending, reaching, or straining to apply a given liquid to a particular target area of flora. A device of the present inventive concept virtually eliminates physical strain by virtue of a longitudinal shaft component that substantially reduces the need for bending, reaching, or straining. While many other devices require the user to carry a heavy container filled with the liquid to be applied to flora, a device of the present inventive concept greatly reduces this burden on the user by the efficiency of the nozzle component, which optimizes both droplet size and the pressure at which those droplets are applied to flora. When coupled with the hood component, the user is able to apply the liquid with a high degree of precision and efficiency. This uses a lesser volume of liquid, which permits the user to cover a larger area with a comparatively smaller volume of liquid. The hood component assists directionality of intended liquid dispersal, and it also serves the function of shielding the user from unintended spray that may arise in windy conditions. The hood is shaped in a generally conical or pyramid shape. While other devices require the user to impart manual activity to disperse a liquid (such as squeezing a trigger), which can lead to hand fatigue and possible physical maladies, a device of the present inventive concept solves this problem by incorporating an electrical motor component that can be activated with relative ease by the simple activation of a switch. A device of the present inventive concept significantly reduces the strain and physical exertion necessary for a user to engage in agricultural endeavors.

Additionally, a device of the present inventive concept offers improved precision and efficiency in delivering an herbicide or other liquid to a target area. A device of the present inventive concept achieves a high level of precision and efficiency by controlling the volume of liquid delivered and the pressure at which the liquid is delivered. The nozzle expels the liquid to a target area in a predetermined droplet size at a predetermined pressure optimized for delivery of the liquid to the target area. By utilizing such a nozzle, the liquid is delivered in a highly efficient manner, since the optimal droplet size and optimal pressure ensure that a minimal volume of liquid is used to achieve maximal effect (i.e., herbicidal properties). When the hood component is incorporated with a device of the present inventive concept, the precision and accuracy of liquid delivery is improved, while simultaneously shielding the user from potential exposure to the liquid droplets. By combining the hood component with the nozzle component, the liquid is delivered in an extremely precise and efficient manner to the target area. The incorporation of a dye also provides visual confirmation to the user that the intended area has been treated with the agricultural liquid. Thus, a device of the present inventive concept addresses the need for a device that delivers an agricultural liquid efficiently, which achieves the goals of reducing environmental impact and maximizing use of the liquid by only affecting targeted areas.

A device of the present inventive concept further includes an electrical motor. The incorporation of a motor removes the need for user manipulation of a trigger or other similar mechanism. The motor automates delivery of the agricultural liquid, while simultaneously removing user strain from the application process. The motor also interacts with the nozzle to deliver the liquid at an optimal pressure and at a controlled volume. The nozzle further controls droplet size, which optimizes precision and accuracy of application and also uses the liquid in a highly economical and efficient manner. The handle houses a container to hold liquid. The switch, which controls the motor component, is also located on the handle. A device of the present inventive concept may also incorporate an indicator component, such as a colored dye, which is added to the container of agricultural liquid. User movement mixes the indicator component and the agricultural liquid.

Another object of the present inventive concept is to provide a method of dispersing fluid by using a portable motorized fluid delivery device apparatus. The method includes adding a volume of fluid to the device. In some examples, the device includes a removable container to ease the handling of fluid transfer. The method further includes positioning the device such that the nozzle is located at a predetermined height directly over a target. In some embodiments, the hood component is sized and shaped such that it provides guidance to the user with respect to positioning the device. When the device is in the desired position, the electrical switch is activated such that the electrical motor engages the fluid pump to disperse a portion of the fluid from the handle of the apparatus, through the shaft, and out through the nozzle in the base. In some situations, the device is configured to disperse a predetermined volume of fluid automatically every time the switch is activated. In other situations, the device is configured to disperse fluid continuously until the switch is manually deactivated.

The user activates the motor component by turning the switch to the “on” position. The motor component then pumps the fluid (e.g., dye and herbicide mixture) from the container housed in the handle through the longitudinal shaft to the nozzle. The fluid is expelled through the nozzle at optimal droplet size and pressure for proper application to a target area. The hood component further ensures accurate placement of the liquid mixture to the target area, while also shielding the user from possible errant spray that can result in windy conditions.

When an indicator (e.g., a colored dye) is mixed with the fluid, additional advantages are realized. Once the dyed fluid is applied to a target area, the dye will show the user where the fluid has been applied. The dye dissipates after a period of time. Sometimes, the indicator is a liquid dye that is activated by ultraviolet light. The indicator acts as visual confirmation that the agricultural liquid has been applied to a target area. After a period of time, the indicator dissipates by virtue of its interaction with ultraviolet light, temperature, rain or other environmental factors.

Another object of the present inventive concept is to provide a method of manufacturing a portable motorized fluid delivery device apparatus. A switch, electronic circuitry to connect the switch to the power source and (eventually) the motor, and a sealed structure capable of containing a volume of fluid are arranged within a handle housing to form a handle of the device. A cavity capable of transferring fluids from one end of the shaft to the opposite end of the shaft and an electrical connection between opposing ends of the shaft are arranged alongside (i.e., non-coaxial) each other to form the elongated shaft of the device. An electrical motor, a fluid pump, and a nozzle are arranged within a housing to form a base of the device. The handle and base are affixed to the elongated shaft such that when the electrical switch is activated the electrical motor engages the fluid pump to disperse a portion of the fluid from the handle of the apparatus, through the shaft, and out through the nozzle in the base.

The foregoing and other objects are intended to be illustrative of the general inventive concept and are not meant in a limiting sense. Many possible embodiments of the invention may be made and will be readily evident upon a study of the entire specification and accompanying drawings comprising a part thereof. Various features and subcombinations of the general inventive concept may be employed without reference to other features and subcombinations. Other objects and advantages of the general inventive concept will become apparent from the following description taken in connection with the accompanying drawings, wherein is set forth by way of illustration and example, an embodiment of this invention and various features thereof.

### BRIEF DESCRIPTION OF THE DRAWINGS

These and/or other aspects and utilities of the present general inventive concept will become apparent and more readily appreciated from the following description of the embodiments, taken in conjunction with the accompanying drawings. For the purpose of illustration, forms of the present general inventive concept which are presently preferred are shown in the drawings; it being understood, however, that the general inventive concept is not limited to the precise arrangements and instrumentalities shown. In the drawings:

FIG. 1 is a perspective exterior view of an exemplary embodiment of the present general inventive concept.

FIG. 2 is an enlarged cutaway view of the base and distal shaft end of the exemplary embodiment of FIG. 1.

FIG. 3 is an enlarged exterior view of the handle of the exemplary embodiment of FIG. 1.

FIG. 4 is a perspective exterior view of a second exemplary embodiment of the present general inventive concept.

FIG. 5 is a top view of the exemplary embodiment of FIG. 4.

FIG. 6 is a side view of the exemplary embodiment of FIG. 4.

FIG. 7 is an enlarged perspective view of the handle of the exemplary embodiment of FIG. 4.

FIG. 8 is an enlarged cutaway view of the handle of the exemplary embodiment of FIG. 4.

### DETAILED DESCRIPTION

The present general inventive concept provides a portable motorized fluid delivery device apparatus. The device includes a handle. The handle is ergonomically sized and shaped to be comfortably held by a user's hand(s). The handle includes a compartment where it can receive and hold a predetermined volume of fluid. In some embodiments, the fluid compartment is a container that is separable and removable from the device. In some embodiments, the fluid compartment includes a removable lid, such as a screw cap. In some embodiments, the fluid compartment is configured to hold approximately 16 ounces of fluid.

In some embodiments, the fluid is an herbicide. In some embodiments, the herbicide is mixed with an indicator, such as a colored dye. In some embodiments, the indicator is visible with unaided human eyesight in ordinary daylight. The incorporation of a dye provides visual confirmation to the user that the intended area has been treated with the fluid. Thus, a device of the present inventive concept addresses the need for a device that delivers an agricultural liquid efficiently, which achieves the goals of reducing environmental impact and maximizing use of the liquid by only affecting targeted areas. Use of the dye helps the user avoid inadvertent duplicate application of the fluid to overlapping target areas.

The handle also includes an electrical switch, which controls the dispersal of fluid. In some embodiments, the switch is located on the handle such that it can be easily activated by the user's thumb. In some embodiments, the switch is located on the handle such that it can be easily activated by the user's forefinger. In some embodiments, the switch is a simple switch, capable of being actuated between two positions—“on” and “off”. In some embodiments, the switch includes variable settings to vary the length of time that fluid is dispersed, the volume of fluid that is dispersed, or the intended distance from the nozzle to the target (which could depend in factors such as fluid viscosity, fluid pressure at the nozzle, or size and shape of the hood). In some embodiments, the switch is more complex.

The switch is connected to an electrical power source. In some embodiments, the power source is one or more electrical batteries, such as standard 9-volt, D size, or AA size batteries. In some embodiments, the one or more batteries are located within a cavity within the handle. In some embodiments, the one or more batteries are located within a cavity within the elongated shaft. In some embodiments, the one or more batteries are located within a cavity within the base of the device. In some embodiments, the power source is alternating current (NC) electrical power and the device is plugged in to the power source via an extension cord.

The device includes an elongated shaft. The elongated shaft extends outward and away from the handle. When in ordinary use, the shaft extends downward from the handle toward the ground. The shaft includes a cavity capable of transferring fluid from one end to the opposite end. At one end of the shaft that is proximal to the user, the shaft is connected to the handle. The shaft cavity is in fluid connection with the fluid compartment within the handle such that fluid can be pumped out of the handle and down through the shaft when the switch is activated. At the opposite end of the shaft, the end that is distal to the user, the shaft is connected to the base of the device. In some embodiments, the shaft is made of aluminum. In some embodiments, the shaft is about 30 inches in length.

The device includes an electrical motor and fluid pump. The electrical motor and fluid pump are connected to the switch and power source such that the fluid is pumped from the fluid compartment in the handle, down the shaft and out through a nozzle in the base when the switch is activated. In some embodiments, the motor and/or pump are located within the base of the device. In some embodiments, the motor and/or pump are located within the shaft of the device. In some embodiments, the motor and/or pump are located within the handle of the device.

In the base of the device is a nozzle. The nozzle is in fluid connection with the cavity of the shaft such that fluid can transfer out of the handle, through the shaft, through the base, and out the nozzle, when the switch is activated. The nozzle is sized and shaped to disperse fluid in a special spray pattern. The nozzle is sized and shaped such that, when the switch is activated and the pump is engaged, fluid exits the nozzle within the range of 10 to 45 psi. The nozzle also sized and shaped such that the fluid droplets expelled from the nozzle are medium to coarse in size, which means that the fluid droplets are between 100 and 450 microns in size.

In some embodiments, the base includes a hood. In some embodiments, the hood surrounds the nozzle on 4 sides to partially enclose the nozzle at the point where fluid is ejected from the nozzle. In some embodiments the hood is separate and removable from the base of the device. In some embodiments, the hood is permanently affixed to the base of the device. In some embodiments, the hood and the base are a single, unibody component. In some embodiments, the hood extends away from the nozzle at a predetermined distance to aid the user in maintaining a consistent and uniform minimum distance between the nozzle and the target. In some embodiments, the hood is shaped in a generally conical or pyramid shape. The hood also reduces the influence of wind and other environmental factors on fluid dispersal pattern after the fluid leaves the nozzle. The hood also helps the user more accurately focus on the target. The hood component assists directionality of intended liquid dispersal, and it also serves the function of shielding the user from unintended spray that may arise in windy conditions.

The present general inventive concept also provides methods of dispersing fluid by using the portable motorized fluid delivery device apparatus described herein. In some embodiments, fluid is added directly to the fluid compartment within the handle. In some embodiments, the fluid container is separate and removable from the device and fluid transfer is more efficiently performed by simply removing the empty fluid container and replacing it with a full container.

The device is positioned such that the nozzle is located at a predetermined height directly over a target. The optimal height above the target is dependent on a number of factors, for example the velocity of the wind at the time and location of use. On very windy days, to reduce the likelihood of unwanted misdirection of fluid, the bottom of the hood is placed on or in very close proximity to the ground and then the motor is engaged. When there is little to no wind, the device need not include the hood component, as long as the device is positioned such that the distance between the nozzle and the target is within the range of zero (i.e., in contact with the ground) to about 12 inches above the ground. In most instances, the optimal height (i.e., distance of nozzle from target) is between 2 to 6 inches.

Use of the hood component provides guidance to the user with respect to positioning the device. For example, the user can visually inspect the target and make sure that the target is located under the hood before engaging the motor and pump. Also, the hood component is sized and shaped such that the bottom of the hood component is a predetermined distance away from the nozzle. For example, in one embodiment, the hood component is sized and shaped such that the distance from the nozzle to the bottom of the hood component is about three (3) inches. In this example, the user is assured of consistent and optimal nozzle height over the target by simply positioning the hood over the target with the bottom of the hood touching or in very close proximity to the ground or target.

When the device is in the desired position, the electrical switch is activated such that the electrical motor engages the fluid pump to disperse a portion of the fluid from the handle of the apparatus, through the shaft, and out through the nozzle in the base. In some embodiments, the device is configured to disperse a predetermined volume of fluid automatically every time the switch is activated. In some embodiments, this predetermined volume of fluid is between less than 1 ml and 2 ml. In some embodiments, the device is configured to disperse fluid continuously until the switch is manually deactivated, at a rate of approximately 60 ml to 100 ml per minute. In some embodiments, manual deactivation of the switch occurs by actuating the switch to an “off” position. In some embodiments, manual deactivation of the switch occurs by pressing a button.

In some embodiments, the user activates the motor and pump by turning the switch to an “on” position. The motor then pumps the fluid (e.g., dye and herbicide mixture) from the container housed in the handle through the longitudinal shaft and out through the nozzle. The fluid is expelled through the nozzle at optimal droplet size and pressure for proper application to the target area. The hood component further ensures accurate placement of the liquid mixture to the target area at the optimal distance, while also shielding the user from possible errant spray that can result in windy conditions.

When an indicator (e.g., a colored dye) is mixed with the fluid, additional advantages are realized. Once the dyed fluid is applied to a target area, the dye will show the user where the fluid has been applied. The dye dissipates after a period of time. Sometimes, the indicator is a liquid dye that is activated by ultraviolet light. The indicator acts as visual confirmation that the agricultural liquid has been applied to a target area. After a period of time, the indicator dissipates by virtue of its interaction with ultraviolet light. Rain and other environmental factors also effect the dissipation of the indicator.

The present general inventive concept also provides methods of manufacturing a portable motorized fluid delivery device apparatus. A switch, electronic circuitry to connect the switch to the power source and (eventually) the motor, and a sealed structure capable of containing a volume of fluid are arranged within a handle housing to form a handle of the device. A cavity capable of transferring fluids from one end of the shaft to the opposite end of the shaft and an electrical connection between opposing ends of the shaft are arranged alongside (i.e., non-coaxial) each other to form the elongated shaft of the device. An electrical motor, a fluid pump, and a nozzle are arranged within a housing to form a base of the device. The handle and base are affixed to the elongated shaft such that when the electrical switch is activated the electrical motor engages the fluid pump to disperse a portion of the fluid from the handle of the apparatus, through the shaft, and out through the nozzle in the base.

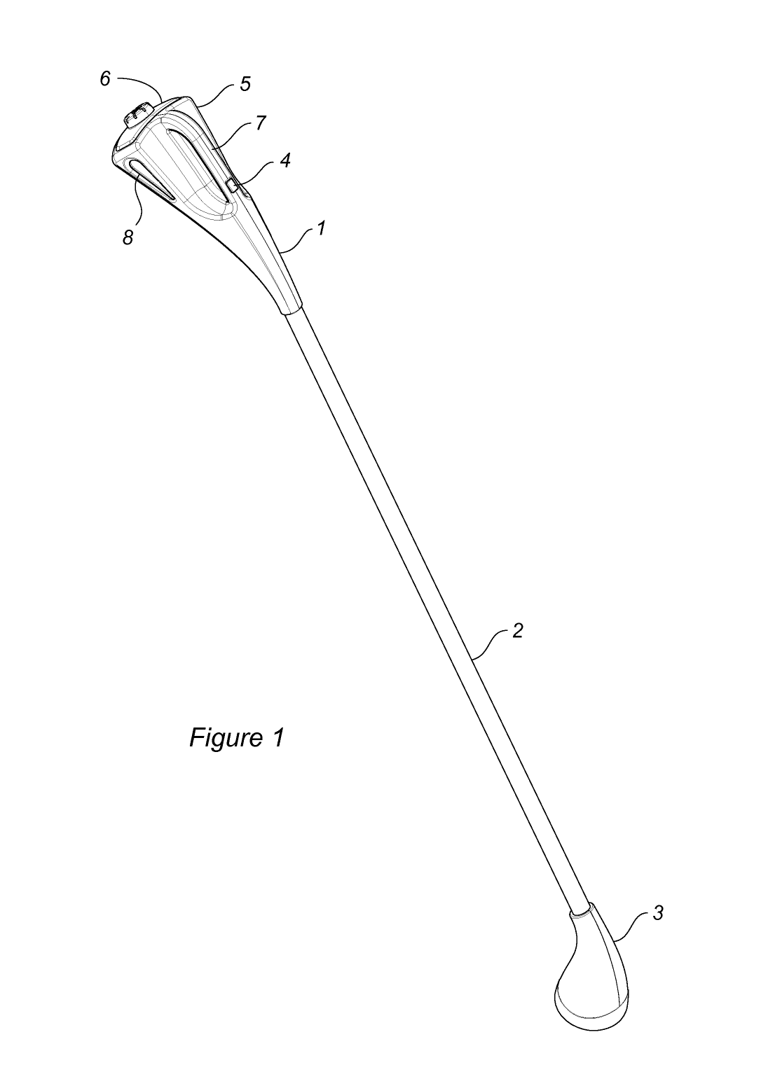

Referring to the Figures, FIG. 1 depicts a perspective exterior view of an exemplary embodiment of the present general inventive concept. A base 3 is affixed to the distal end of an elongated shaft 2. The proximal end of the elongated shaft 2 is affixed to a handle 1. The handle 1 includes a primary grasping area 7. A switch 4 is located on the handle 1 near the primary grasping area 7. The switch 4 is sized, shaped and located in a manner that permits the user to simultaneously hold the primary grasping area 7 and also activate the switch 4. A fluid container 6 is also included in the handle 1 via a housing area 5. The handle 1 also includes a window 8 sized and shaped such that the user can visually determine the volume of fluid in the fluid container 6. In some embodiments, the fluid container 6 and/or the window 8 include one or more markings such that the volume of fluid can be more easily measured. In use, the window 8 can optionally be used as a secondary grasping area, for example in a two-handed use configuration. Two-handed optional use is beneficial in some embodiments, as user stature and strength will vary. The two-handed optional use allows users of smaller stature or lesser strength to utilize the invention with greater ease. When prepared for application of a fluid, the user holds the primary grasping area 7, positions the base 3 over a target area, and activates the switch 4. Upon activation of the switch 4, fluid is pumped from the fluid container 6 in the housing area 5 of the handle 1, through the elongated shaft 2, to the base 3 via a motor (not shown in the Figures) housed in the base 3. The fluid is dispersed through the base 3 and out through a nozzle (not shown in the Figures) housed within the base 3.

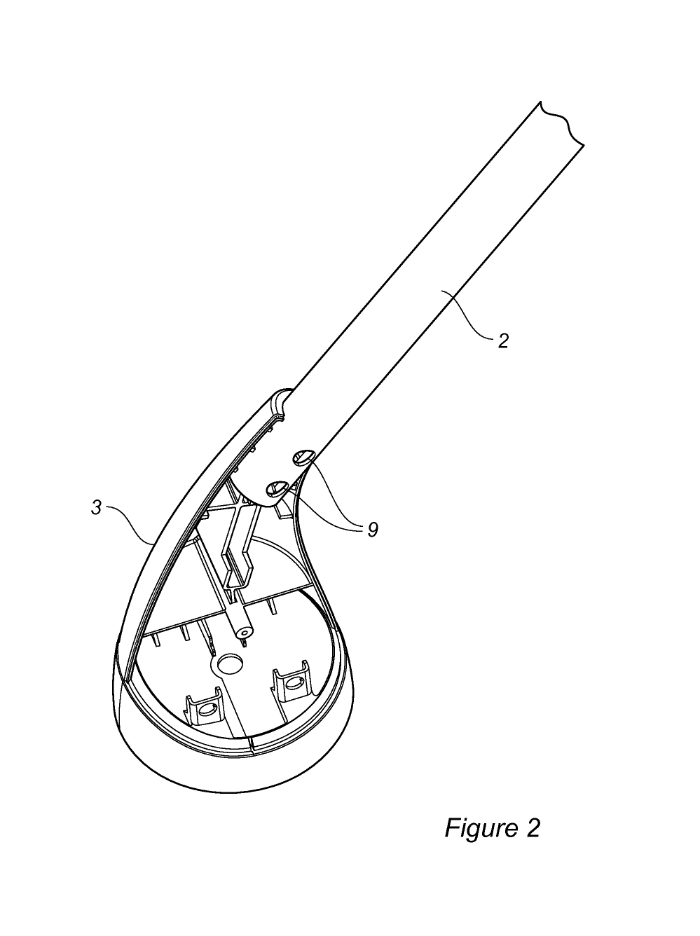

FIG. 2 shows an enlarged cutaway view of the base 3 and distal end of the elongated shaft 2 of the exemplary embodiment of FIG. 1. In the exemplary embodiment shown in FIG. 2, the distal end of the elongated shaft 2 is connected to the base 3 by an attachment 9, including by way of example a series of screws, dowels, pegs, or clips. The removable nature of the elongated shaft 2 from the base 3 permits the user to easily clean and maintain the device. The removable property also provides the added benefit of creating a diversity of storage options.

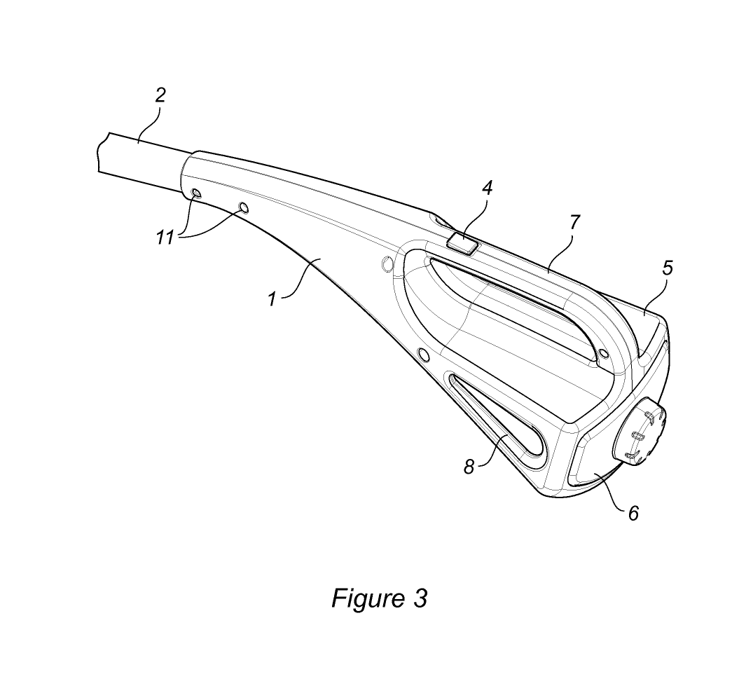

FIG. 3 is an enlarged exterior view of the handle 1 of the exemplary embodiment of FIGS. 1 and 2. As shown in FIG. 3, the proximal end of the elongated shaft 2 is connected to the handle 1 by an attachment 11, including by way of example a series of screws, dowels, pegs, or clips. The removable nature of the elongated shaft 2 from the handle 1 permits the user to easily clean and maintain the device. The removable property also provides the added benefit of creating a diversity of storage options. Fluid to be dispersed is contained in the fluid container 6, which the invention accommodates in the housing area 5. FIG. 3 also shows the window 8 in the handle 1, through which the user can visually inspect fluid levels. The window 8 can also optionally be used as a secondary grasping area.

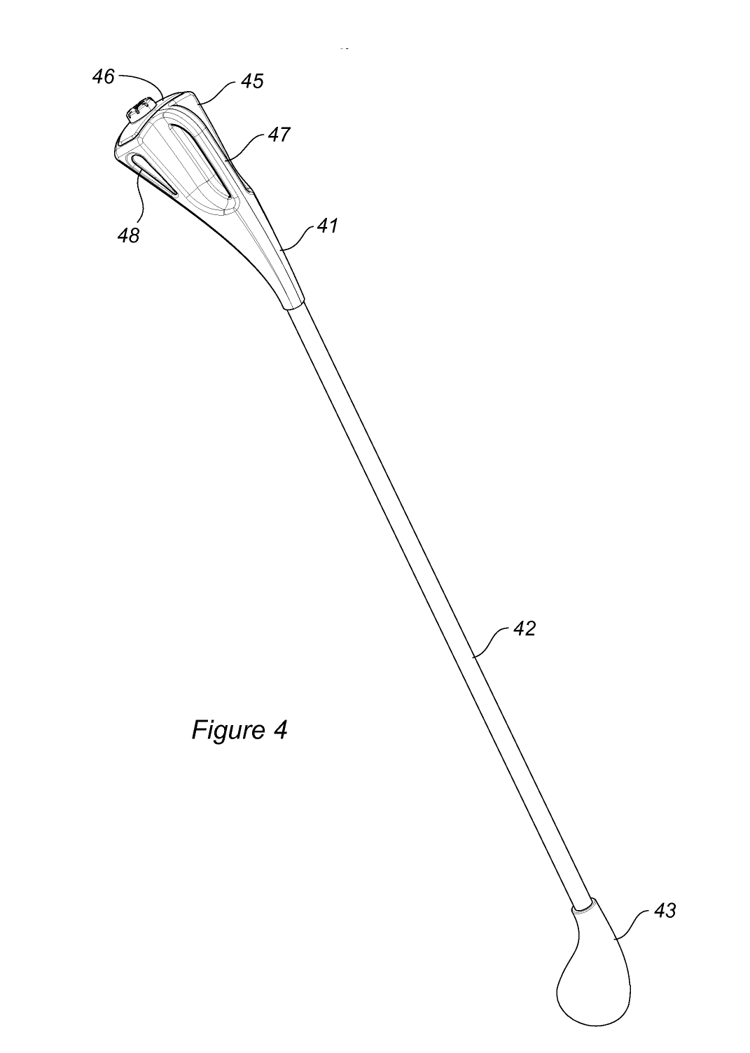

FIG. 4 is a perspective exterior view of a second exemplary embodiment of the present general inventive concept. In FIG. 4, a base 43 is attached to the distal end of an elongated shaft 42. The proximal end of the elongated shaft 42 is connected to a handle 41 of the device. A user holds a primary grasping area 47 on the handle 41. FIG. 4 also shows a window 48 in the handle 41, which the user can optionally utilize as a secondary grasping area. A fluid container 46 holds the fluid to be dispersed. The device accommodates the fluid container 46 via a housing area 45, such that the fluid container 46 is integrated into the device.

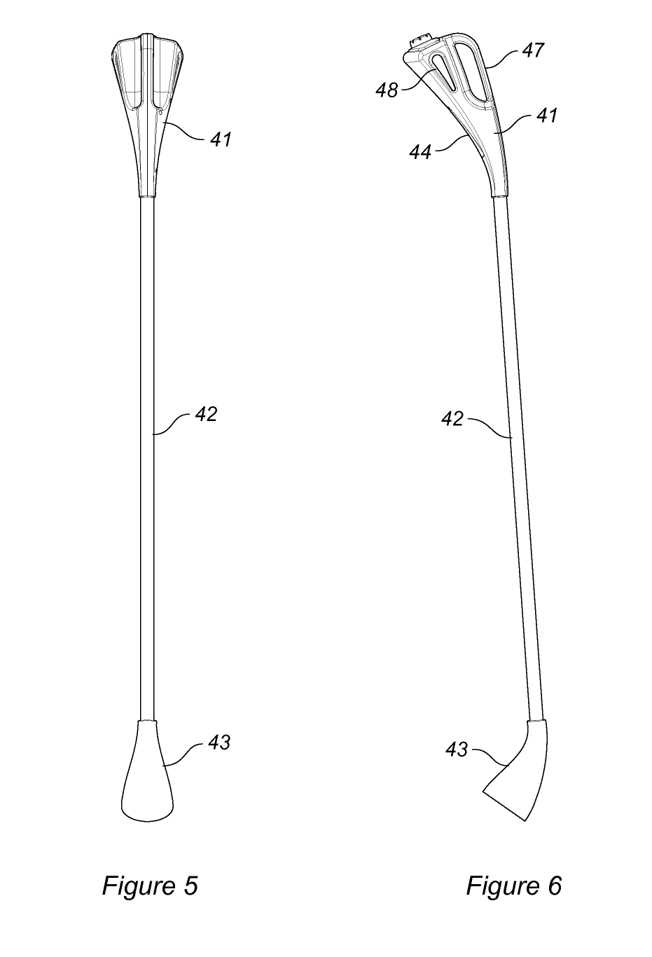

FIG. 5 is a top view of the exemplary embodiment of FIG. 4. FIG. 5 depicts the handle 41 being affixed to the elongated shaft 42 at the proximal end. FIG. 5 further shows the distal end of the elongated shaft 42 affixed to the base 43 of the device.

FIG. 6 is a side view of the exemplary embodiment of FIGS. 4 and 5. As shown in FIG. 6, a switch 44 is located on the underside of the handle 41. A user operates the device of this embodiment by holding the primary grasping area 47. The user's other hand is used to activate the switch 44, or alternatively, the user can simultaneously hold the window 48 and activate the switch 44.

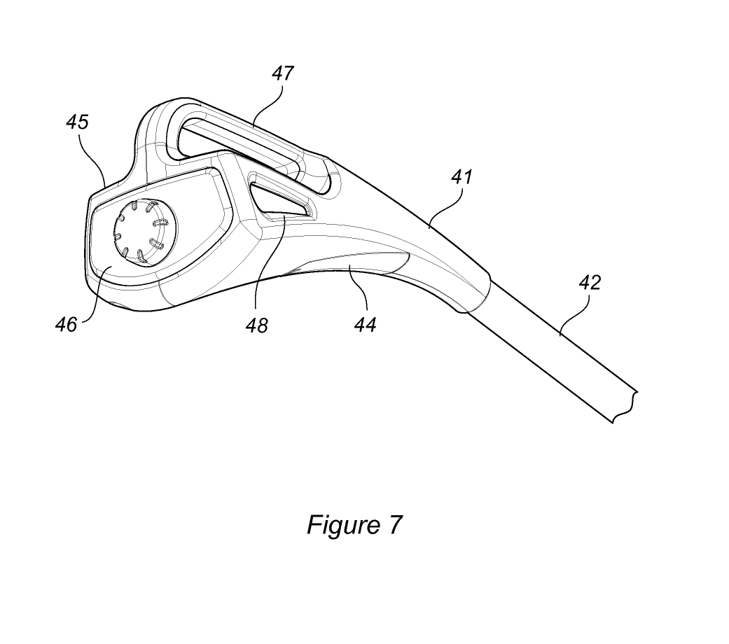

FIG. 7 is an enlarged perspective view of the handle 41 of the exemplary embodiment of FIGS. 4-6. The proximal end of the elongated shaft 42 is affixed to the handle 41. FIG. 7 shows the switch 44. When the switch 44 is activated, the motor housed in the base 43 pumps fluid out of the fluid container 46 in the housing area 45, through the elongated shaft 42, and out of the base 43 and nozzle. FIG. 7 also shows the window 48 in the handle 41.

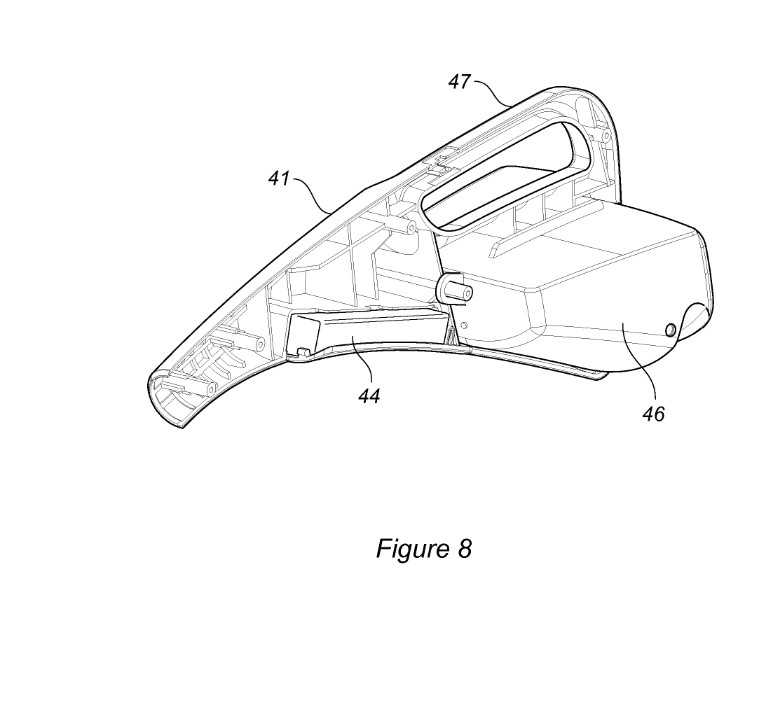

FIG. 8 is an enlarged cutaway view of the handle 41 of the exemplary embodiment of FIGS. 4-7. FIG. 8 shows the switch 44, the fluid container 46, and the primary grasping area 47 of the handle 41.

Thus, while the present general inventive concept has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use; applications in contexts outside of lawn and garden care.

It is also to be understood that the claims to follow are or will be intended to cover all of the generic and specific features of the invention herein described, and all statements of the scope of the invention which, as a matter of language, might be said to fall therebetween. Hence, the proper scope of the present general inventive concept should be determined only by the broadest interpretation of such claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed is:

1. An apparatus comprising:
a handle portion sized and shaped to receive and contain a predetermined volume of fluid, said handle portion further comprising an electrical switch connected to an electrical power source;
an elongated shaft extending away from said handle portion;
a base portion affixed to a distal end of said elongated shaft;
an electrical motor and fluid pump operably connected to said handle portion, said switch, said elongated shaft, and said base portion such that said electrical motor engages said fluid pump to disperse a portion of said predetermined volume of fluid out through a nozzle in said base portion in a predetermined spray pattern when said electrical switch is activated;

2. The apparatus of claim 1, wherein said fluid is an herbicide.

3. The apparatus of claim 1, wherein said handle portion is sized and shaped to receive a container of fluid.

4. The apparatus of claim 1, further comprising a hood affixed to said base portion.

5. The apparatus of claim 4, wherein said hood is generally conical in shape.

6. The apparatus of claim 1, wherein said fluid comprises an indicator.

7. The apparatus of claim 6, wherein said indicator is visible to unaided human eyesight.

8. The apparatus of claim 6, wherein said indicator dissipates within a measurable period of time.

9. The apparatus of claim 6, wherein said indicator interacts with ultraviolet light.

10. The apparatus of claim 1, wherein said power source is an alternating current power supply.

11. The apparatus of claim 1, wherein said power source is one or more battery.

12. The apparatus of claim 11, wherein said one or more battery is located within said base portion.

13. The apparatus of claim 11, wherein said one or more battery is located within said handle portion.

14. The apparatus of claim 11, wherein said one or more battery is located within said elongated shaft.

15. The apparatus of claim 1, wherein said electrical motor is located within said base portion.

16. The apparatus of claim 1, wherein said electrical motor is located within said handle portion.

17. The apparatus of claim 1, wherein said electrical motor is located within said elongated shaft.

18. The apparatus of claim 1, wherein said fluid pump is located within said base portion.

19. The apparatus of claim 1, wherein said fluid pump is located within said handle portion.

20. The apparatus of claim 1, wherein said fluid pump is located within said elongated shaft.

21. The apparatus of claim 1, wherein when said fluid is dispersed out through said nozzle, said fluid is dispersed at a pressure of between 10 psi and 45 psi.

22. The apparatus of claim 1, wherein when said fluid is dispersed out through said nozzle, said fluid is dispersed in medium to course sized droplets.

23. The apparatus of claim 22, wherein said droplets are sized between 100 and 450 microns in diameter.

24. A method of dispersing a fluid, said method comprising:
adding a predetermined volume of fluid to the apparatus of claim 1;
positioning said apparatus such that said nozzle is located at a predetermined height over a target;
activating said electrical switch such that said electrical motor engages said fluid pump to disperse a portion of said predetermined volume of fluid from said handle of said apparatus, through said elongated shaft of said apparatus, and out through said nozzle in said base portion of said apparatus;

25. The method of claim 24, further comprising deactivating said electrical switch.

26. A method of manufacturing the apparatus of claim 1, said method comprising:
arranging a switch and electronic circuitry to connect the switch to the power source and the motor, and a sealed structure sized and shaped to contain a volume of fluid, within a handle housing to form said handle portion of the apparatus of claim 1;
arranging a cavity capable of transferring fluids from one end of the shaft to the opposite end of the shaft and an electrical connection between opposing ends of the shaft alongside each other to form said elongated shaft of the apparatus of claim 1;
arranging said electrical motor, said fluid pump and said nozzle within a solid exterior housing to form said base portion of the apparatus of claim 1;
affixing said handle portion to a proximal end of said elongated shaft; and
affixing said base portion to a distal end of said elongated shaft, such that when the electrical switch is activated the electrical motor engages the fluid pump to disperse a predetermined volume of fluid from the fluid container in the handle of the apparatus, through the shaft, and out through the nozzle in the base.
